(19) United States
(12) Patent Application Publication
(10) Pub. No.: US 2005/0100673 A1
(43) Pub. Date: May 12, 2005

(54) Method for the surface treatment of a doctor element

(76) Inventors: Ulrich Schoof, Dusseldorf (DE); Stefan Reimann, Meerbusch (DE)

Correspondence Address: TAYLOR & AUST, P.C., 142 SOUTH MAIN STREET, P. O. BOX 560, AVILLA, IN, 46710, US

(21) Appl. No.: 10/992,348

(22) Filed: Nov. 19, 2004

Related U.S. Application Data
(63) Continuation of application No. PCT/EP03/50161, filed on May 14, 2003.

(30) Foreign Application Priority Data
May 22, 2002 (DE) 102 22 453.6

(51) Int. Cl. B05C 11/02; B05C 1/08; B05D 3/12

(52) U.S. Cl. 427/356; 118/261; 118/123; 427/357

(57) ABSTRACT

A method for the surface treatment of a doctor element including a steel alloy, in particular austenitic steel, for coating devices. The doctor element is subjected to a gas plasma-assisted treatment, the gas plasma containing nitrogen and carbon compounds and at least one noble gas, preferably argon. During the treatment, foreign metal foreign ions, in particular titanium and molybdenum, are implanted directly into the steel surface of the doctor element.

### CROSS REFERENCE TO RELATED APPLICATIONS

This is a continuation of PCT application No. PCT/EP03/50161, entitled “METHOD FOR SURFACE TREATMENT OF A DOCTOR BLADE ELEMENT”, filed May 14, 2003.

### BACKGROUND OF THE INVENTION

1. Field of the Invention

The present invention relates to a method for the surface treatment of a doctor element which includes a steel alloy, in particular austenitic steel.

2. Description of the Related Art

Doctor elements are used in application and metering systems of apparatuses for coating fibrous webs, in particular webs of paper or board. These apparatuses are a constituent part of online or offline coating machines for the production of the fibrous web.

The doctor elements, which are used in the form of metering rods, metering bars or as doctor blades, are used for the purpose of doctoring off liquid or pasty medium, in particular pigmented coating color, applied in excess to a transfer element or directly to the material web, to the desired coat weight, or only for evening out said medium. The doctor elements nowadays have lengths of 10 m and more, corresponding to the machines, which are required to be wider and wider. The metering rods, metering bars or doctor blades either have a smooth surface (EP 0654643B1) or a grooved profiled surface (DE 3022955).

Since the doctor elements are subjected particularly highly to wear, in particular when coating abrasive pigmented coating colors and as a result of the high running speed of the web, at present these elements are produced from a basic body made of steel and provided with a layer of a hard material. It is known to fabricate this hard material layer from chromium (EP 0454643B1) or ceramic (DE 3937749A1). The production of such a layer is both expensive and very time-consuming.

In addition, the service life of such types of “strengthened doctor elements” is still too short. For this reason, in DE 19840951A1, it has been proposed to subject metering rods which have an aforementioned hard material layer to an ion implantation process. By way of a reaction between the hard material (of the chromium or the ceramic) with ions applied in a plasma, the hardness of the metering rods is intended to be increased, but above all cracks in the surface are to be closed. However, this finishing process is also costly.

Furthermore, typical production faults, such as chromium-plating faults or irregularities may occur, primarily in ceramic coatings, as a result of which the metering rod is no longer suitable for its actual purpose, namely the production of a uniform application layer over the entire width and length of the fibrous web.

What is needed in the art are doctor elements which have a long service life and, furthermore, can be produced economically and in an environmentally friendly manner.

### SUMMARY OF THE INVENTION

The present invention provides doctor elements which have long service life and which can be produced economically and in an environmentally friendly manner.

The invention comprises, in one form thereof a method for the surface treatment of a doctor element including a steel alloy, in particular austenitic steel, for coating devices. The doctor element is subjected to a gas plasma-assisted treatment, the gas plasma containing nitrogen and carbon compounds and at least one noble gas, preferably argon. During the treatment, foreign metal foreign ions, in particular titanium and molybdenum, are implanted directly into the steel surface of the doctor element.

The invention comprises, in another form thereof a doctor element for a coating apparatus, which includes a steel alloy, in particular austenitic steel, characterized by a surface treated as described above, which has a hardness of 900 to 1800 HV, preferably 1000 to 1200 HV.

The invention comprises, in yet another form thereof an apparatus for the direct or indirect application of a liquid or pasty medium to a moving surface. The moving surface in the case of direct application is the surface of a material web, in particular of a paper or board web, and in the case of indirect application is the surface of a transfer element, for example an applicator roll, which discharges the medium to the material web. The transfer element includes an application and metering system which can be set against the moving surface, characterized in that the metering system contains a doctor element as described above.

Completely surprisingly, it has been shown that an ion implantation process in plasma can also be used in austenitic locations and leads to an increase in the surface hardness (measured according to Vickers). Following the treatment, the doctor elements have a surface hardness of 900 to 1800 HV, preferably 1000 to 1200 HV.

This is all the more significant since, because of the risk of embrittlement as a result of the formation of chromium carbide and the intercrystalline corrosion, austenitic steels containing chromium were not considered to be capable of being hardened, or only poorly so, since hardening was always accompanied by an impairment of the corrosion finishing. These disadvantages are avoided by the present invention.

The fact that the incorporation of the foreign ions can be carried out in a transcrystalline manner, that is to say in the metal lattice, denotes that these undesired effects mentioned above can be avoided and, for the first time, makes the finishing method according to the present invention possible. The main advantages of a doctor element treated in this way lie in the improved technological properties and in its prolonged service life.

Further expedient possible refinements are contained in the dependent claims.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a cylindrical metering bar as a doctor element according to the present invention; and

FIG. 2 is a cross-sectional view of an embodiment of a metering bar as a doctor element according to the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

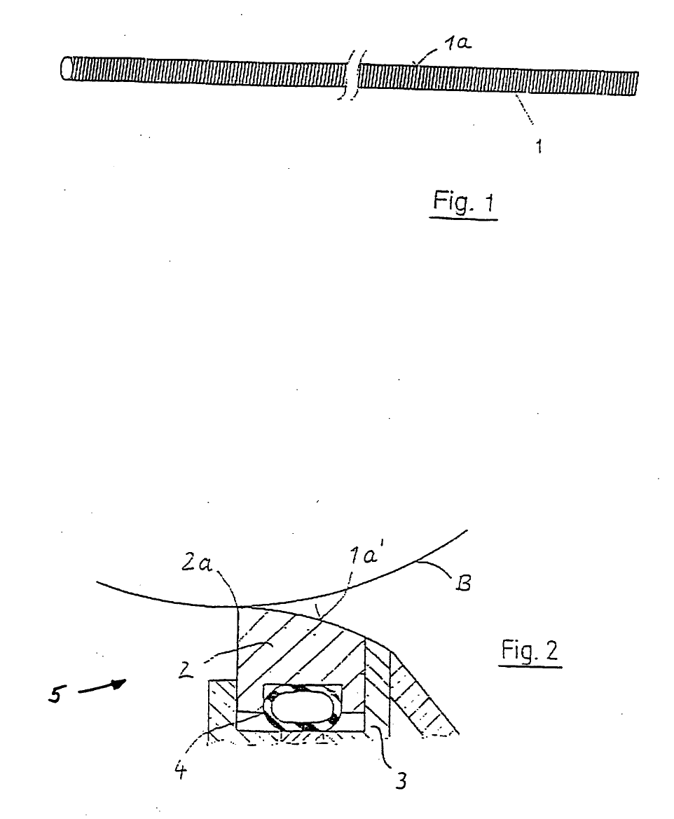

Referring now to the drawings, and, more particularly to FIG. 1, there is shown a cylindrical metering rod 1 which includes a steel alloy which can be an austenitic steel. Its diameter depends on the type of application medium, on the type of material to be coated (fine paper, special paper, base board and so on) and on the application thickness (coat weight in grams per square meter). The diameter is generally 8 mm to 80 mm. All diameters have proven to be suitable for treatment with the ion implantation process of the present invention.

Depending on the application, circumferential surface 1a is formed so as to be smooth or else provided with circumferential grooves, which are introduced in the manner of a helix. The aforementioned grooves, which are also shown in FIG. 1, are used for the volumetric metering of the application medium. The metered quantity in this case corresponds to the free cross-section of the grooves.

FIG. 2 shows an apparatus for the direct or indirect application of a liquid or pasty medium to a moving surface B, in particular of a paper or board web, which includes an application and metering system 5. Metering bar 2 illustrated in FIG. 2, like metering rod 1, includes a steel alloy which can be an austenitic steel and can have a surface as described in FIG. 1. In the example, this surface is formed so as to be smooth and is designated 1a′. Furthermore, metering bar 2 has a sharp tear-off edge for accurate doctoring of the medium. The tear-off edge is designated 2a.

In the case of direct application, moving surface B is a material web and metering bar 2, set against material web B, can have a flat, convex or concavely shaped surface 1a. In the example of FIG. 2, this is convexly shaped. Metering bar 2 is arranged on a supporting element 3, merely indicated, and supported compliantly against the latter. In this case, the support is provided by a pressure hose 4.

Both doctor elements 1 and 2 shown are treated or finished with an ion implantation process of the present invention. This is carried out by their austenitic steel body being bombarded directly with high-energy ions in the gas plasma state. The gas plasma includes nitrogen and carbon compounds as well as at least one noble gas such as argon or helium.

The foreign ions used are primarily titanium and also molybdenum, tungsten, vanadium, chromium and boron ions. A selection of ion types matched to the respective substrate and the intended use are used.

The ions are injected to a depth of up to 0.15 mm, preferably 0.02 to 0.05 mm. The treatment or finishing process is carried out at temperatures of preferably 50-650° C., and 70° and 400° C. and a residence time in the gas plasma phase of up to 60 hours. The doctor elements treated in this way then have a surface hardness of 900 to 1800 HV, preferably 1000 to 1200 HV.

As a result, the surface of doctor elements 1 and 2 is very finely crystalline and, consequently, is able to apply the coating material more uniformly than hitherto to a paper or board web. The service life of the doctor elements is at least as good as previous doctor elements which additionally have a layer of hard material on the steel body.

Doctor element 1 or 2 finished by the method according to the present invention, as already mentioned, is preferably used in a coating apparatus for one-sided or two-sided, direct or indirect application. In the case of indirect application, moving element B is a transfer element, and the application medium is either applied to transfer element B, for example an applicator roll, from which the paper web picks up the medium in a press nip, or the medium is applied directly to the web in the case of direct application. Then, by using application and metering system 5 which can contain either doctor elements 1 or 2, the medium previously applied in excess is doctored off to a desired extent or the layer applied is only evened out. The application medium, in particular pigment-containing medium, for coating or pigmenting the material web, in particular of paper or board, can have acted on the material web for a relatively long time before doctoring (in the case of LDTA, i.e. long dwell time applicator) and also only a short time (in the case of SDTA, i.e. short dwell time applicator).

In this case, what are known as roll application methods and also nozzle application methods (e.g. JetFlow, SpeedFlow and so on) are possible as the application method.

The method according to the present invention can be used both during the new production of the doctor elements and also for the post-treatment of the doctor elements.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for the surface treatment of a doctor element for coating devices, the doctor element comprised of a steel alloy and a steel surface, comprising the steps of:
providing a gas plasma containing a plurality of nitrogen and carbon compounds and at least one noble gas;
subjecting the doctor element to a gas plasma-assisted treatment using said gas plasma; and
implanting a plurality of foreign metal foreign ions directly into the steel surface of the doctor element during said gas plasma-assisted treatment.

2. The method of claim 1, wherein the steel alloy is an austenitic steel.

3. The method of claim 1, wherein said noble gas is argon.

4. The method of claim 1, wherein said plurality of foreign metal foreign ions includes at least one of titanium and molybdenum.

5. The method of claim 1, further including the step of implanting a plurality of further foreign ions having at least one of tungsten, vanadium, chromium and boron.

6. The method of claim 1, further including the step of introducing said foreign ions into the surface of the doctor element to a depth of not greater than approximately 0.15 mm.

7. The method of claim 6, wherein said depth is approximately between 0.02 and 0.05 mm.

8. The method of claim 1, further including the step of introducing said foreign ions in a transcrystalline manner.

9. The method of claim 1, wherein said gas plasma-assisted treatment includes a duration not greater than approximately 60 hours.

10. The method of claim 1, wherein said gas plasma-assisted treatment is carried out at temperatures not greater than approximately 650° C.

11. The method of claim 1, further including a working region provided for doctoring and being associated with the doctor element, at least said working region being provided with said gas plasma-assisted treatment.

12. A doctor element for a coating apparatus, comprising:
a steel alloy, and
a surface being treated with a gas plasma-assisted treatment having a gas plasma containing a plurality of nitrogen and carbon compounds and at least one noble gas, a plurality of foreign metal foreign ions directly implanted into said surface of the doctor element during said gas plasma-assisted treatment, said surface having a hardness of approximately between 900 HV and 1800 HV.

13. The doctor element of claim 12, wherein said steel alloy is an austenitic steel.

14. The doctor element of claim 12, wherein said hardness is approximately between 1000 HV and 1200 HV.

15. The doctor element of claim 12, wherein said surface is one of a grooved surface and a smooth surface.

16. The doctor element of claim 12, wherein the doctor element is formed as a rotatable cylindrical metering rod with a diameter of approximately between 8 mm and 80 mm.

17. The doctor element of claim 16, wherein said diameter is approximately between 8 mm and 50 mm.

18. The doctor element of claim 12, wherein the doctor element is formed as a stationary metering bar, said surface includes a sharp tear-off edge.

19. An apparatus for one of a direct application and an indirect application of one of a liquid medium and a pasty medium to a moving surface, the moving surface in the case of the direct application being a surface of a fiber web, the moving surface in the case of the indirect application being a surface of a transfer element, the apparatus discharging one of said liquid medium and said pasty medium to the moving surface, comprising:
an application and metering system being set against the moving surface, said system including a doctor element comprised of a steel alloy and a surface being treated with a gas plasma-assisted treatment having a gas plasma containing a plurality of nitrogen and carbon compounds and at least one noble gas, a plurality of foreign metal foreign ions directly implanted into said surface of the doctor element during said gas plasma-assisted treatment, said surface including a hardness of approximately between 900 HV and 1800 HV.

20. The apparatus of claim 19, wherein said fiber web is one of a paper web and a board web.

21. The apparatus of claim 19, wherein said transfer element is an applicator roll.
